(19) United States
(12) Patent Application Publication
(10) Pub. No.: US 2026/0055575 A1
(43) Pub. Date: Feb. 26, 2026

(54) BRAKE SYSTEM

(71) Applicant: J.C. BAMFORD EXCAVATORS LIMITED, Uttoxeter (GB)

(72) Inventor: David Arredondo, Uttoxeter (GB)

(21) Appl. No.: 19/305,141

(22) Filed: Aug. 20, 2025

(30) Foreign Application Priority Data
Aug. 20, 2024 (GB) 2412260.8
Sep. 9, 2024 (DE) 10 2024 208 558.8

(51) Int. Cl. E02F 9/12; E02F 3/32; E02F 9/20; E02F 9/24; F16D 59/00; F16D 121/00; F16D 121/20; H02K 3/04; H02K 7/102

(52) U.S. Cl. CPC E02F 9/128; E02F 9/123; E02F 9/2083; E02F 9/24; F16D 59/00; H02K 3/04; H02K 7/102; E02F 3/325; F16D 2121/005; F16D 2121/20

(57) ABSTRACT

A working machine including: a substructure; a superstructure rotatable relative to the substructure about a generally vertical slew axis; an electric slew motor arranged to slew the superstructure in rotation relative to the substructure about the slew axis; and a slew brake system including a motor driver circuit. The electric slew motor includes a motor winding with first and second terminals coupled to the motor driver circuit, and the slew brake system is arranged to selectively directly electrically couple the first and second terminals together to provide a short-circuit braking effect.

### FIELD

The present disclosure relates to a slew brake system of an electric slew motor and a working vehicle including a slew brake system.

### BACKGROUND

Working machines (also working vehicles) such as excavators, backhoe loaders, telehandlers, skid-steer loaders, dumpers and the like often have one or more hydraulically actuated devices such as working arm actuators, track motors, bucket actuators, slew actuators etc. Such hydraulically actuated devices operate by receiving a flow of hydraulic fluid from a hydraulic pump.

A slew actuator of a working machine is arranged to rotate (i.e., slew) a superstructure relative to the substructure about a generally vertical slew axis. The superstructure may comprise a cabin, user inputs, a working arm, bucket, and one or more hydraulically actuated devices such as working arm actuators, bucket actuators. Thus, when slewed, the superstructure can have a large amount of momentum due to its heavy weight. It may be necessary, during operation of the working machine, to halt the working machine quickly if an emergency situation or a fault is detected, or a manual emergency stop button activated by a user. To halt the working machine quickly a mechanical brake can be engaged to rapidly decelerate the superstructure of the working machine, effectively bringing it to a complete stop in relation to the substructure. The mechanical brake system operates utilizing frictional resistance generated by brake pads in contact with a rotor or similar component. The engagement of the mechanical brake may be both immediate and forceful, halting movement of the superstructure to prevent potential harm or damage.

Due to the immediate and forceful nature of the activation of the mechanical brake when bringing the superstructure to a stop, wear on the mechanical brake occurs. This may require regular maintenance or replacement of the mechanical brake, which results in downtime for the working machine.

The present disclosure seeks to overcome, or at least mitigate, one or more problems of the prior art.

### SUMMARY

A first aspect of the disclosure provides a working machine comprising: a substructure; a superstructure rotatable relative to the substructure about a generally vertical slew axis; an electric slew motor arranged to slew the superstructure in rotation relative to the substructure about the slew axis; a slew brake system optionally comprising a motor driver circuit; the electric slew motor optionally comprising a motor winding with first and second terminals coupled to the motor driver circuit; wherein the slew brake system may be arranged to selectively directly electrically couple the first and second terminals together to provide a short-circuit braking effect.

The slew brake system may be arranged to directly electrically couple the first and second terminals together in the absence of one of: a non-short-circuit control signal; or power to the slew brake system.

The motor driver circuit may comprise switchable transistors configured to directly electrically couple the first and second terminals together.

The motor driver circuit may be an inverter, and the inverter may comprise the switchable transistors each having a control terminal and a first and second channel terminals. Each transistor may be arranged such that its first and second channel terminals are directly electrically coupled when no control signal is present on its control terminal.

The slew brake system may further comprise a mechanical brake system.

The slew brake system may be configured to, in an emergency mode: directly electrically couple the first and second terminals together and operate the mechanical brake system simultaneously, to provide the short-circuit braking effect to the electric slew motor in response to a brake control signal.

The mechanical brake system may comprise a mechanical brake. The mechanical brake system may be configured to operate the mechanical brake to provide a mechanical braking effect to the electric slew motor.

The mechanical brake system may be operated to: actuate the mechanical brake to disengage the mechanical brake and, not actuate the mechanical brake to engage the mechanical brake to provide a mechanical braking effect to the electric slew motor.

The mechanical brake may be actuated via a solenoid. The solenoid may be biased to engage the mechanical brake to provide a mechanical braking effect to the electric slew motor. Advantageously, blending the electric motor braking with the solenoid may reduce cost and energy usage.

The mechanical brake may be arranged to dissipate 6000 Joules of rotational energy from a rotor of the electric slew motor if the mechanical brake is engaged.

The mechanical brake system may be configured to engage the mechanical brake if the rotational speed of a rotor of the electric slew motor is greater than a speed threshold. Advantageously, this enables effective braking while reducing brake wear.

The mechanical brake system may be configured to disengage the mechanical brake once the rotational speed of a rotor of the electric slew motor is reduced to less than the speed threshold.

The electric slew motor may be a 3-phase motor. The first terminal may be a U-terminal. The second terminal may be a V-terminal. The electric slew motor may further comprises a W-terminal and a neutral terminal.

The emergency braking event may comprise one or more of: a signal from an emergency stop button; a determination that the power sink is full such that the regenerative brake system cannot provide further energy to the power sink; a hydraulic system fault event; a controller fault event; a loss of power; a loss of communications.

The motor driver circuit may be coupled to a power source and configured to operate the electric slew motor to slew the superstructure relative to the substructure.

The slew brake system may comprise a regenerative brake system.

The regenerative brake system may be configured to operate the motor driver circuit to receive energy from the electric slew motor operating as a generator and provides energy to a power sink such as an energy store or a system requiring electrical power, to provide a regenerative braking effect.

The slew brake system may be further configured to, in an exception mode: determine that the power sink is unavailable for receiving energy; and/or directly electrically couple the first and second terminals together in response to determining that the power sink is unavailable.

The slew brake system may further be configured to, in a normal mode: detect one or more user brake inputs; provide a mechanical braking effect and/or a regenerative braking effect based on the one or more user brake inputs; and/or not provide the short-circuit braking effect.

### BRIEF DESCRIPTION OF THE DRAWINGS

Embodiments of the disclosure will now be described with reference to the accompanying drawings, in which:

FIG. 1 is a side view of a working vehicle according to an example;

FIG. 2 schematically illustrates a simplified slew brake system for the working machine of FIG. 1;

FIG. 3 schematically illustrates a slew brake system for the working machine of FIG. 1;

FIG. 4 schematically illustrates a slew brake system for the working machine of FIG. 1, with optional additional features;

FIG. 5 schematically illustrates a slew brake system for the working machine of FIG. 1, with optional additional features;

FIG. 6 is a control flow diagram representing processes of operating the slew brake system of any of FIGS. 2 to 5;

FIG. 7 shows a first diagram representing the angular distance travelled by the superstructure of the working machine to reduce its rotational speed from a low speed to stationary according to an example;

FIG. 8 shows a second diagram representing the angular distance travelled by the superstructure of the working machine to reduce its rotational speed from a high speed to stationary according to an example; and

FIG. 9 is a control flow diagram representing processes of operating the slew brake system of FIG. 5.

### DETAILED DESCRIPTION OF EMBODIMENT(S)

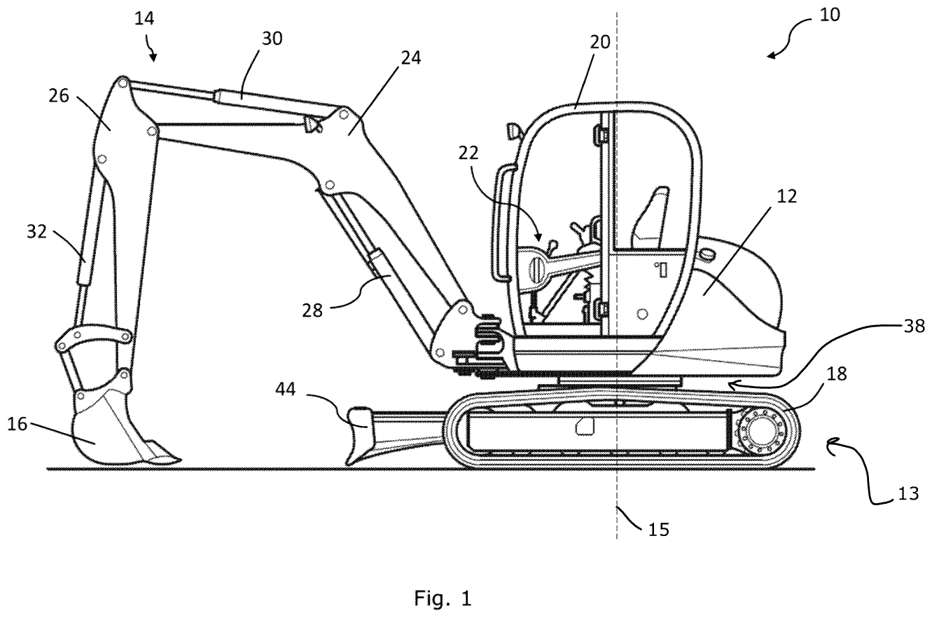

Referring to FIG. 1, a working machine according to an example is indicated at 10. The working machine 10 has a superstructure 12 (e.g. a chassis), a working arm 14 attached to the superstructure 12, and an implement 16 connected to a free end of the working arm 14. The superstructure 12 is rotatable relative to the substructure 13 about a generally vertical slew axis 15. In the illustrated example, the substructure 13 comprises tracks 18 provided to move the working machine 10. In alternative examples, the substructure 13 may be provided to fix the working machine 10 at a location. In alternative examples, wheels may be provided to move the working machine 10, instead of tracks 18.

The working machine 10 includes a cab 20 with a collection of controls 22 for moving the working arm 14, the tracks 18, or controlling other functions of the working machine 10.

The working arm 14 includes a boom 24 pivotally attached to the superstructure 12, a dipper arm 26 pivotally attached to the boom 24, and an implement pivotally attached to the dipper arm 26. In the illustrated example, the implement is a bucket 16, which is used for soil-shifting or materials handling operations (e.g. trenching, grading, and loading) and/or materials handling (e.g. depositing aggregate in trenches, lifting materials and placing them on an elevated platform). In alternative examples, the bucket 16 may be removed and replaced with an alternative implement, such as a hydraulic hammer drill.

A boom actuator 28 is provided to move the boom 24 in an ascending direction and a descending direction. The working machine 10 also includes a dipper actuator 30, for pivoting the dipper arm 26 with respect to the boom 24, and a bucket actuator 32, for pivoting the bucket 16 with respect to the dipper arm 26.

The working machine 10 also includes left and right track motors for moving the left and right tracks 18 forwards or backwards; an electric slew motor 38 for slewing the superstructure 12 relative to the substructure 13; a swing actuator for pivoting the working arm 14 about a vertical axis relative to the superstructure 12; a dozer actuator for actuating a dozer blade 44; and a track extend actuator 46 for varying a length of the tracks 18. In some examples, the working machine 10 also includes one or more auxiliary hydraulic ports (not shown). The electric slew motor 38 arranged to slew the superstructure 12 in rotation relative to the substructure 13 about the slew axis 15.

In the illustrated example, the working machine 10 is a slew excavator. In alternative examples, the working machine 10 may be any type of working machine including one or more hydraulically actuated devices 28, 30, 32.

The working machine 10 also includes a hydraulic system for controlling the hydraulically actuated devices 28, 30, 32.

In some examples, the working vehicle 10 is an electric working vehicle, a fuel cell powered working vehicle (e.g. a working vehicle including a hydrogen fuel cell) or hybrid working vehicle of the kind having an electric source of power and an alternative source of power. The aspects of the disclosure described below have been found to provide improved slew braking, in particular in an emergency, fault, or exception state of the machine. This leads to an improved robustness and improved efficiencies in operation and manufacture when the slew system is used on an electric working vehicle 10.

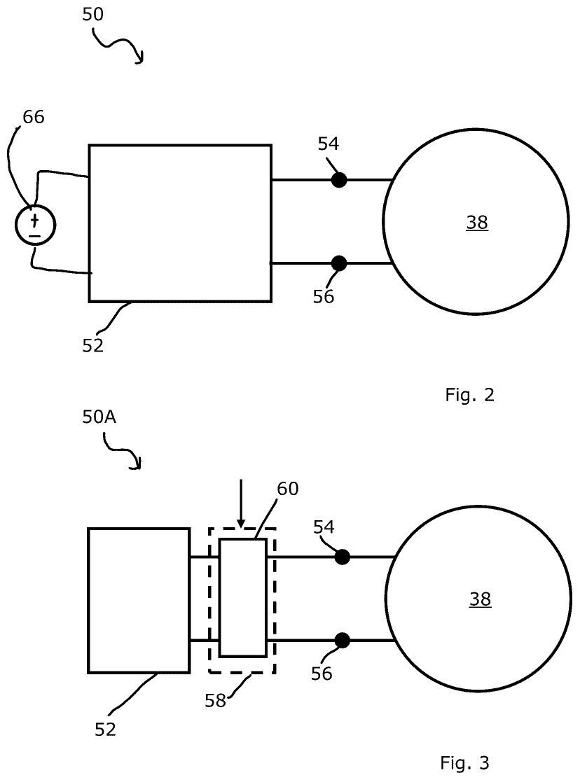

Referring now to FIG. 2, a simplified slew brake system for the working machine 10 of FIG. 1 is indicated at 50. The simplified slew brake system 50 comprises the electric slew motor 38 of the working machine 10, and a motor driver circuit 52. In some examples, the electric slew motor 38 may be a single-phase motor, although multi-phase motors can also be implemented in the system. The electric slew motor 38 comprises a motor winding with a first terminal 54 and second terminals 56 coupled to the motor driver circuit 52. The slew brake system 50 is arranged to selectively directly electrically couple the first and second terminals 54, 56 together to provide a short-circuit braking effect.

In an example, the motor driver circuit 52 is coupled to a power source 66 and configured to operate the electric slew motor 38 to slew (i.e., rotate) the superstructure 12 relative to the substructure 13. Under normal, non-braking conditions, the motor driver circuit 52 is configured to operate the electric slew motor 38 in a motoring mode. In the motoring mode the motor driver circuit 38 receives energy from the power source 66 and provides energy to the electric slew motor 38 operating as a motor.

In the technical field of working machines, the skilled person has a strong technical prejudice to presume that short-circuiting the first and second terminals 54, 56 may result in large currents within the windings of the electric slew motor 38 which would damage the electric slew motor 38. This is further particularly true within the industry of working machines, where reliability is an important factor for a skilled person to consider.

The inventors, therefore, were particularly surprised to discover that the electric slew motor 38 is not adversely affected by the large transient currents generated as a result of short-circuiting the first and second terminals 54, 56 together. This Is particularly true when short-circuit braking is used intermittently, for example in response to emergency or other non-regular braking events, and not in steady-state conditions, such as may occur in a traction systems, for example for providing extended slowing or braking of a vehicle, such as when a vehicle is descending a negative slope.

Advantageously, the short-circuit braking effect acts to reduce the speed of the rotor of the electric slew motor 38 quickly and effectively. This reduces wear on a mechanical brake of the working machine 10, which would otherwise be required to act alone to reduce the slew speed of superstructure and the rotor of the electric slew motor 38. This improves reliability of the working machine 10 and reduces the amount of maintenance required.

In an example, the slew brake system 50 of the working machine 10 may operate in at least one mode of operation, which may be one or more of: an emergency mode, an exception mode; and/or a normal mode.

In the normal mode the working machine 10 is operated within typical operating parameters. In the normal mode, the motor driver circuit 52 may drive the electric slew motor 38, such as, in response to one or more user inputs (such as, the collection of controls 22) of the working machine 10. In the normal mode the slew brake system 50 may provide normal braking, such as, a mechanical braking effect (e.g., from a mechanical brake system) and/or a regenerative braking effect (e.g., from a regenerative brake system 59). Normal braking may to control the [decelerating] rotation of the electric slew motor 38, such as, in response to a normal braking signal. The normal braking signal may be generated based upon one or more user inputs (such as an input taken via the collection of controls 22) to the working machine 10. In the normal mode the slew brake system 50 does not provide the short-circuit braking effect.

In the emergency mode and/or exception mode, the working machine 10 may determine that the working machined 10 is not being operated within typical operating parameters.

In the emergency mode, the working machine 10 may operate to rapidly decelerate and bring the electric slew motor 38 (and thus the superstructure 12) to a stop. That is, stopping the electric slew motor may also be equivalently described as: stopping the rotor of the electric slew motor 38; reducing the relative movement between the rotor and the stator to zero; stopping slew of the superstructure 12; and/or reducing the relative movement between the superstructure 12 and the substructure 13 to zero.

In the exception mode, the working machine 10 may operate to controllably decelerate the electric slew motor 38 (and thus the superstructure 12) to either a reduce its rotational speed or bring the electric slew motor 38 to a stop.

The slew brake system 50 may be configured to operate in an emergency mode upon detecting an emergency braking event or otherwise determining that an emergency braking event has occurred. A brake control signal may be generated by the working machine 10 in response to determining or detecting an emergency braking event or its occurrence. The emergency braking event may be any event which necessitates that the superstructure 12 should be stopped relative to the substructure 13. An example of an emergency braking event may comprise one or more of: activating an emergency stop button; a determination that the power sink is at capacity (i.e., full) or unavailable for receiving energy such that a regenerative brake system 59 cannot provide further energy to the power sink; a hydraulic system fault event; a controller fault event; a loss of power; a loss of communication; or any fault detected by a controller 63 of the working machine 10.

In the emergency mode and/or the exception mode the slew brake system 50 may be arranged to selectively directly electrically couple the first and second terminals 54, 56 together to provide the short-circuit braking effect in response to the brake control signal and/or the absence of one of: a non-short-circuit control signal; or power to the slew brake system 50. The non-short-circuit control signal may be provided to the slew brake system 50 to control the first and second terminals 54, 56 not to directly electrically couple together. If slew brake system 50 determines that the non-short-circuit control signal is absent, then the first and second terminals 54, 56 are directly electrically coupled together to provide the short-circuit braking effect. That is, short-circuit braking may therefore be understood as a ‘normally-on’ system or process. In some examples, the non-short-circuit control signal is the brake control signal, such that the brake control signal commands the slew brake system 50 to directly electrically couple the first and second terminals together or not, and in the absence of the brake control signal, by default, the slew brake system 50 directly electrically couples the first and second terminals 54, 56 together.

The working machine 10 may demand that the electric slew motor 38 is stopped in the emergency mode, and/or the exception mode. If the working machine demands that the electric slew motor 38 is stopped, then this may be equivalent to the working machine 10 demanding that the superstructure 12 does not move relative to the substructure 13.

In an example, the motor driver circuit 52 may comprise switchable transistors operated to, in the exception or emergency mode, directly electrically couple the first and second terminals 45, 56 together.

The motor driver circuit 52 may be an inverter. The inverter may convert DC voltage to an AC voltage suitable for applying to the first and second terminals 54, 56 of the electric slew motor 38. The switchable transistors may be operated to, in the normal mode, drive the electric slew motor 38.

FIG. 3 illustrates a slew brake system for the working machine 10 of FIG. 1 as indicated at 50A. The slew brake system 50A of FIG. 3 shows all of the features of the slew brake system 50 of FIG. 2, in addition to certain optional features. The same reference numerals are used to denote the same/corresponding features in relation to FIG. 2 and will not be described in detail again below.

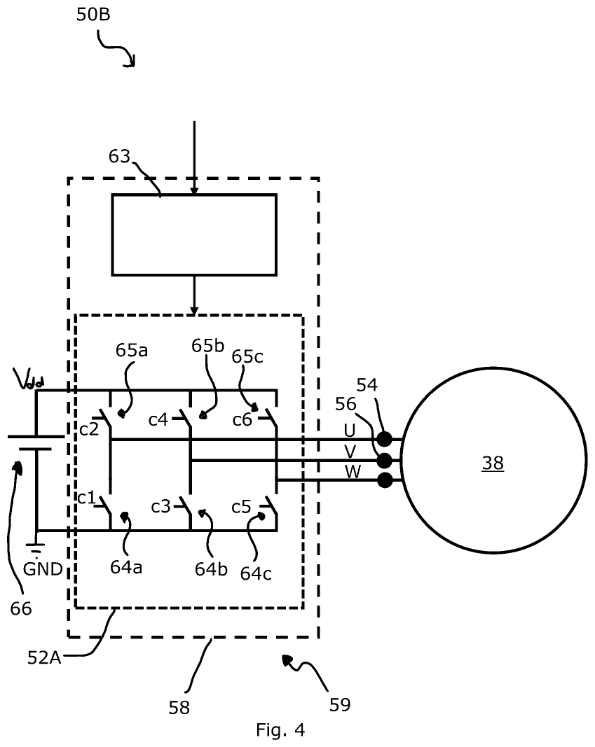

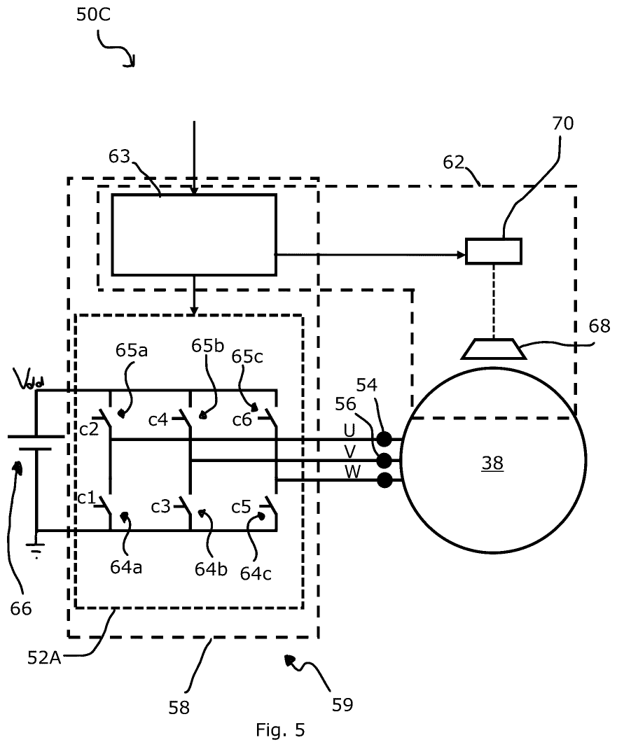

The slew brake system 50A may comprise a short-circuit brake system 58 arranged to directly electrically couple the first and second terminals together to provide the short-circuit braking effect. The short-circuit brake system 58 may be separate from the motor driver circuit 52, or the short-circuit brake system 58 may comprise the motor driver circuit 52 (as will be described in an example illustrated by FIGS. 4 and 5).

In the example illustrated in FIG. 3, the short-circuit brake system 58 comprises a short-circuit device 60 arranged between the motor driver circuit 52 and electric slew motor 38. In the exception mode or emergency mode the short-circuit device 60 may be operated to directly electrically couple the first and second terminals together, and optionally isolate the motor driver circuit 52 from the electric slew motor 38. The short-circuit device 60 may comprise one or more switches, transistors, and/or relays, etc.

FIG. 4 illustrates a slew brake system for the working machine 10 of FIG. 1 as indicated at 50B. The slew brake system 50B of FIG. 4 shows all of the features of the slew brake system 50 of FIG. 2, in addition to certain optional features. The same reference numerals are used to denote the same/corresponding features in relation to FIG. 2 and will not be described in detail again below.

The slew brake system 50B may further comprise a controller 63. The controller 63 may be the central controller of the working machine 10, or may be a distinct controller. The controller 63 may be configured to determine an emergency braking event. The controller 63 may be configured to generate the non-short circuit control signal, and optionally stop generating the non-short circuit control signal in response to the emergency braking event. The controller 63 may be configured to generate the brake control signal in response to determining the emergency braking event. The controller 63 may be configured to control the motor driver circuit 52 to provide the short-circuit braking effect in response to an emergency braking event. The brake control signal and/or the non-short-circuit control signal may be provided to the motor driver circuit 52 to selectively directly electrically couple the first and second terminals 54, 56 together.

As described above, in an example, the motor driver circuit 52 may be an inverter 52A. The inverter 52A may comprise switchable transistors 64a, 64b, 64c, 65a, 65b, 65c. In an example, the switchable transistors 64a, 64b, 64c, 65a, 65b, 65c are operated to, in the exception mode or emergency mode, directly electrically couple the first and second terminals 54, 56 together. In an example, the switchable transistors 64a, 64b, 64c, 65a, 65b, 65c are operated to, in the normal mode, drive the electric slew motor 38.

Each transistor 64a, 64b, 64c, 65a, 65b, 65c may comprise a respective control terminal c1, c3, c5, c2, c4, c6 and respective first and second channel terminals.

In an example, each transistor 64a, 64b, 64c, with one channel terminal directly coupled to ground (GND) is arranged to be closed when no control signal (e.g., GND, 0V, Vss) is present on its control terminal c1, c3, c5, and optionally, the remaining transistors 65a, 65b, 65c are arranged to be open when no control signal is present on their control terminals c2, c4, c6. In an alternative example, each transistor 65a, 65b, 65c, with one channel terminal directly coupled to a voltage signal (Vdd) is arranged to be closed when no control signal (e.g., GND, 0V, Vss) is present on its control terminal c2, c4, c6, and optionally, the remaining transistors 64a, 64b, 64c are arranged to be open when no control signal (e.g., GND, 0V, Vss) is present on their control terminals c1, c3, c5. Advantageously, in either of the described examples, the terminals U, V, W are directly electrically coupled together to provide a balanced short-circuit braking effect in response to the slew brake system losing power. In a more general sense, a system as described in any of the examples herein may be provided in which a short circuit device is arranged to directly connect terminals of a motor winding together in the absence of a control signal on one or more of its control terminals. Short-circuit braking can therefore be applied in a ‘normally-on’ manner, so that in the absence of power, the non-short-circuit control signal, and/or control signals, the slew braking system applies short-circuit braking.

In an example, the slew brake system 50B may comprise a regenerative brake system 59. The slew brake system 50B may comprise the short-circuit brake system 58 and the regenerative brake system 59. The regenerative brake system 59 may comprise the same components as the short-circuit brake system 58. That is, the regenerative brake system 59 may comprise inverter 52A, and the power source/sink 66. Each of the short-circuit brake system 58 and the regenerative brake system 59, may comprise the controller 63. In an alternative example, each of the short-circuit brake system 58 and the regenerative brake system 59 may comprise distinct respective controllers.

In an example, the short-circuit brake system does not comprise or does not engage a distinct power-sink for dissipating power outside of the motor, such as a resistor. That is, the short-circuit brake system is arranged to directly electrically couple the first and second terminals together without a distinct power sink, such as a resistor, such that short-circuit braking energy is dissipated substantially wholly within the winding or windings of the motor. While, in short-circuit mode, a small amount of heat may be dissipated via electrical conductors or electrical control components connecting the terminals of the motor winding or windings, the vast majority of energy may be dissipated in the motor windings, such as over half, over two-thirds, over three quarters, or over 8 or 9 tenths of the energy may be within the winding or windings of the motor. The windings of the electric slew motor 28 have surprisingly been found to be able to dissipate the rotational power from the electric slew motor 38 without the use of a resistor or similar sink or load outside of the motor windings. Power may be dissipated as heat by the one or more windings of the electric slew motor 38. Advantageously, due to the transient nature of the short-circuit braking in the working machine 10, the electric slew motor 38 is not damaged, for example, by excessive current induced heating.

The controller 63 may be configured to control the motor driver circuit 52 to provide a regenerative braking effect in response to a normal braking signal. Advantageously, the regenerative brake system 59 provides effective braking while reducing brake wear on a mechanical brake.

In an example, in the normal mode, the regenerative brake system 59 may be operated to provide the regenerative braking effect. Specifically, the inverter 52A may be operated to provide the regenerative braking effect. For example, the inverter 52A may be configured to operate the switchable transistors 64a, 64b, 64c, 65a, 65b, 65c to receive energy from the electric slew motor 38 operating as a generator and provide energy to a power sink 66, to provide the regenerative braking effect. In the illustrated example, the power sink 66 is a battery. In other examples, the power sink 66 may be an energy storing device, such as a battery or a capacitor, a load, or a system requiring electrical power.

In an example, in the normal mode, the slew brake system may be operated to provide a regenerative braking effect simultaneously to a mechanical braking effect.

FIG. 5 illustrates a slew brake system for the working machine 10 of FIG. 1 as indicated at 50C. The slew brake system 50C of FIG. 5 shows all of the features of the slew brake system 50B of FIG. 4, in addition to certain optional features. The same reference numerals are used to denote the same/corresponding features in relation to FIG. 4 and will not be described in detail again below.

As shown in FIG. 5, the slew brake system 50C comprises, in addition to the short-circuit brake system 58, a mechanical brake system 62. The slew brake system 50C may optionally also comprise the regenerative brake system 59 described with reference to FIG. 4.

The mechanical brake system 62 provides the mechanical braking effect to the electric slew motor 38 to reduce the speed of the rotor of the electric slew motor. That is, the mechanical brake system 62 can reduce the relative rotational speed between the superstructure 12 and the substructure 13.

One or more of the short-circuit brake system 58, the regenerative brake system 59, and the mechanical brake system 62 may comprise the controller 63. In the example of FIG. 5, the controller 63 is shared by the short-circuit brake system 58 and the mechanical brake system 62. In an alternative example, each of the short-circuit brake system 58 and the mechanical brake system 62 may comprise respective distinct controllers.

In an example, the mechanical brake system 62 comprises a mechanical brake 68. The mechanical brake system 62 is configured to operate the mechanical brake 68 to provide the mechanical braking effect to the electric slew motor 38. Specifically, the mechanical brake 68 may be engaged to the rotor (or component thereof) of the electric slew motor 38, to provide the mechanical braking effect to the electric slew motor 38. In an example, the mechanical brake 68 may be engaged to another element of the superstructure 12 and/or the substructure 13 to provide the mechanical braking effect to the electric slew motor 38.

The mechanical brake 68 may be positioned to provide a braking force to the electric slew motor 38 in the absence of the non-short-circuit control signal and/or power to the mechanical brake system 62 (sometimes referred to as being normally-on, N/O). That is, a braking force may be provided in the absence of actuation of the mechanical brake 68. Therefore, the mechanical brake system 62 may engage the mechanical brake 68 to provide the mechanical braking effect to the electric slew motor 38 in the absence of any actuation, by default (e.g., in the absence of a control signal and/or power). If a control signal and/or power is provided to the mechanical brake system 62 then the mechanical brake 68 may be actuated to allow the electric slew motor 38 to rotate without the mechanical braking effect. That is, allow the superstructure 12 to slew relative to the substructure 13. Therefore, the mechanical brake system 62 may disengage the mechanical brake 68 from the electric slew motor 38 in response to actuation.

In an example, the mechanical brake system 62 comprises a solenoid 70. The solenoid 70 may be mechanically biased to engage the mechanical brake 68 to provide the mechanical braking effect to the electric slew motor 38. The biasing mechanism of the solenoid 70 ensures that the mechanical brake 68 is engaged under normal conditions, thereby providing a fail-safe braking mechanism. Therefore, in operation, the mechanical brake 68 can be actuated via the solenoid 70. When the solenoid 70 is activated, it operates to disengage the mechanical brake 68 from the electric slew motor 38. This disengagement allows the electric slew motor 38 to operate without the mechanical braking effect. Conversely, when the solenoid 70 is deactivated, the mechanical brake 68 re-engages with the electric slew motor 38, providing the mechanical braking effect. Advantageously, the solenoid 70 requires power to maintain the mechanical brake 68 in a disengaged position, thus, in the event of power loss, the mechanical brake 68 engages with the electric slew motor 38 to provide the mechanical braking effect. In an alternative example, the solenoid 70 may be replaced with any mechanism with a biasing device suitable for engaging the mechanical brake 68 under normal conditions.

The mechanical brake 68 may arranged (e.g., biased) to dissipate 6000, 5000, 3000, or 1000, Joules of rotational energy from a rotor of the electric slew motor if the mechanical brake is engaged. The dissipated amount is sufficient to stop the slew of the superstructure within a slew angle of 70, 80, 90, or 100 degrees. The amount of energy required to be dissipated may vary based upon the size, geometry, and mass of the superstructure, plus any maximum load the superstructure may be rated to carry and is calculated based upon the angular momentum. Dissipating a proportion of this energy in the motor in short-circuit brake system 58 reduces the amount of energy required to be dissipated in the mechanical brake and can thus increase the life of the mechanical brake and/or enable the mechanical brake to be more efficiently configured.

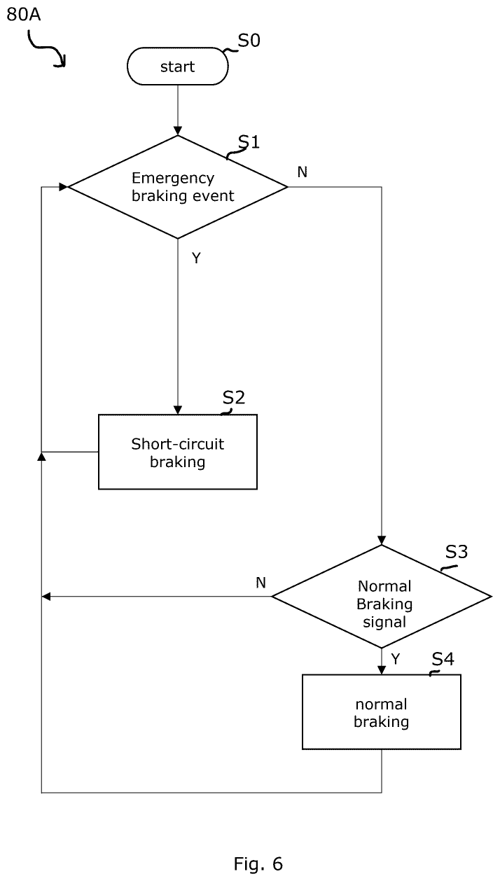

FIG. 6 shows a flow chart 80A of any slew brake system 50, 50A, 50B, 50C described at FIGS. 2 to 5 which may be applied by the controller 63 to provide, in response to determining an emergency braking event, the short-circuit braking effect. Advantageously, the implementation of a short-circuit brake system reduces wear on the components of a slew brake system (e.g., a mechanical brake), which may apply a braking effect in response to a non-emergency braking event and optionally the emergency braking event.

The slew brake system 50, 50A, 50B, 50C described at FIGS. 2 to 5 may perform the step of the short circuit brake system (i.e., step S2) in the emergency mode, and may perform the step of normal braking (i.e., step S4) in the normal mode as shown in FIG. 6.

Specifically, the flow chart 80A of FIG. 6 may comprise the one or more of the following steps. It will be appreciated that sub-sections of the described sequence may be applied to obtain the related advantages, without it being necessary for all steps to be applied in order to realize the advantages of the present disclosure:

At step S0, the process initiates, for example, in response to the working machine 10 being started up.

At decision step S1, the slew brake system determines if there is an emergency braking event. The determination may be based on signals from the working machine 10. If the emergency braking event is determined, then the flow chart 80A moves to step S2. If no emergency braking event is determined, then the flow chart 80A moves to decision step S3.

At step S2, the slew brake system may operate in the emergency mode to operate the short-circuit brake system 58 to provide the short-circuit braking effect in response to an emergency braking event.

At decision step S3, the slew brake system determines if there is a normal braking signal in response to one or more user inputs (such as, the collection of controls 22) of the working machine 10. If a normal braking signal is determined, then the flow chart 80A moves to step S4. If no normal braking signal is determined, then the flow chart 80A moves back to step S1.

At step S4, the slew brake system operates to controllably reduce the rotational speed of the electric slew motor 38 in response to the one or more user inputs (i.e., normal braking). Any controllable brake system may be operated to reduce the rotational speed of the electric slew motor 38. The controllable brake system may be operated to apply a variable braking force corresponding to the variable signal provided by the one or more user inputs. In an example, the controllable brake system may comprise the mechanical brake system 62 and/or the regenerative brake system 59. The mechanical brake system 62 may be operated to controllably reduce the rotational speed of the electric slew motor 38. Alternatively or in addition, the regenerative brake system 59 may be operated to controllably reduce the rotational speed of the electric slew motor 38.

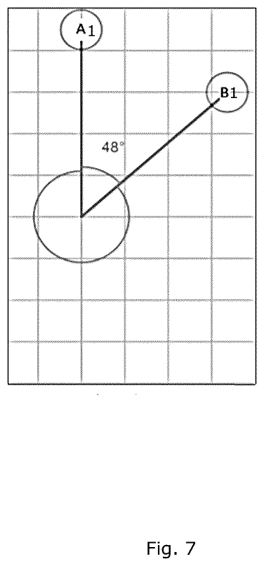

FIG. 7 illustrates a first diagram representing the angular distance travelled by the electric slew motor 38 (e.g., also by the superstructure 12) of the working machine 10 to reduce the rotational speed from 1000 rpm to stationary via the short-circuit braking effect in response to an emergency braking event. Specifically, at point A1 the electric slew motor 38 of the working machine 10 is rotating at 1000 rpm, when the emergency braking event is detected (e.g., step S1, FIG. 5). In response, the short-circuit brake system 58 is operated to rapidly decelerate the electric slew motor 38 of the working machine 10, until the electric slew motor 38 of the working machine 10 stopped at point B1. The rotational distance travelled is shown in FIG. 7 as being 48 degrees.

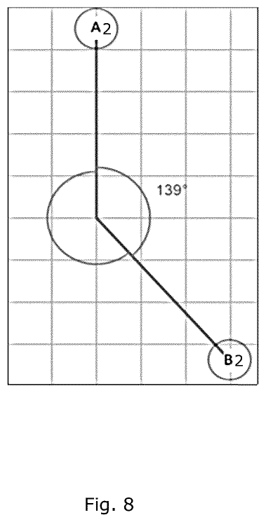

FIG. 8 illustrates a second diagram representing the angular distance travelled by the electric slew motor 38 (e.g., also by the superstructure 12) of the working machine 10 to reduce the rotational speed from 2000 rpm to stationary via the short-circuit braking effect in response to an emergency braking event. Specifically, at point A2 the electric slew motor 38 of the working machine 10 is rotating at 2000 rpm, when the emergency braking event is detected (e.g., step S1, FIG. 5). In response, the short-circuit brake system 58 is operated to rapidly decelerate the electric slew motor 38 of the working machine 10, until the electric slew motor 38 of the working machine 10 stopped at point B2. The rotational distance travelled is shown in FIG. 8 as being 139 degrees.

To reduce the rotational distance travelled by the electric slew motor 38, the slew brake system may be configured to operate the mechanical brake system 62 and the short-circuit brake system 58 simultaneously to provide a braking effect to the electric slew motor 38. Advantageously, this provides more effective braking while reducing wear on the mechanical brake 68.

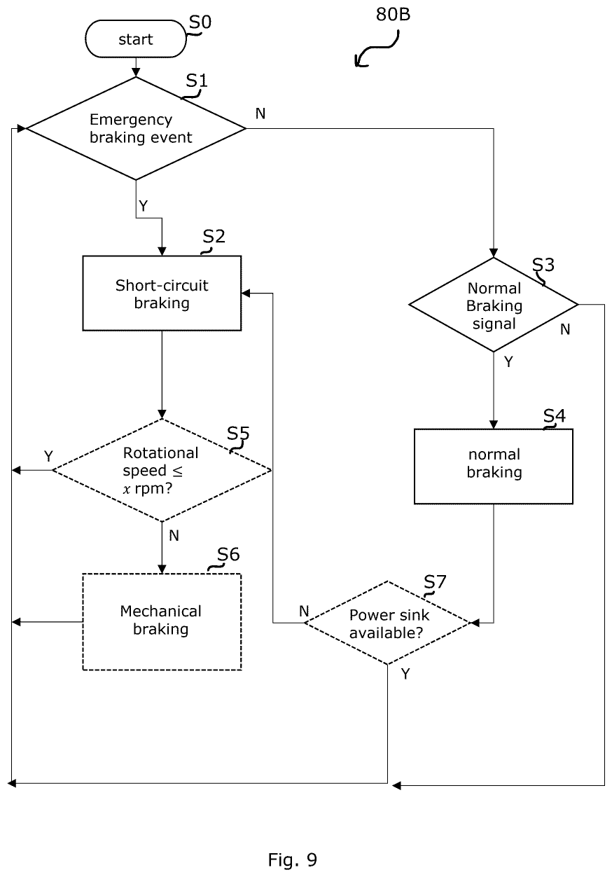

FIG. 9 shows a flow chart 80B of the slew brake system 50C described at FIG. 5 which may be applied by the controller 63 to provide, in response to determining an emergency braking event, a short-circuit braking effect. The flow chart 80B of FIG. 9 shows all of the features of the flow chart 80A of FIG. 6, in addition to certain optional steps. The same reference numerals are used to denote the same/corresponding steps in relation to FIG. 6 and will not be described in detail again below.

The slew brake system 50C described at FIG. 5 may perform the short circuit braking and/or mechanical braking (i.e., steps S2 and/or S6) in the emergency mode (and optionally, the exception mode), and may perform the step of normal braking (i.e., step S4) in the normal mode as shown in FIG. 9.

Specifically, the flow chart 80B of FIG. 9 may the following steps, which may be applied in combination with steps SO to S4. It will be appreciated that sub-sections of the described sequence may be applied to obtain the related advantages, without it being necessary for all steps to be applied in order to realize the advantages of the present disclosure:

At decision step S5, the slew brake system operates in the emergency mode (or optionally, the exception mode) and determines, if possible, the rotational speed of the electric slew motor 38, and compares the rotational speed to a speed threshold, i.e., x rpm. The speed threshold may be equal to any suitable rotational speed which results in the working machine 10 traveling a rotational distance of less than or equal to 90 degrees by the short-circuit brake system 58 (only) in response to an emergency braking event. In an example, the speed threshold is 800 rpm, 1000 rpm, 1200 rpm, 1400 rpm, 1600 rpm, 1800 rpm, 2000 rpm, etc. If the rotational speed of the electric slew motor 38 is ≤the speed threshold, then the flow chart 80B moves to step S1. If the rotational speed of the electric slew motor 38 is not ≤the speed threshold, then the flow chart 80B moves to step S6.

At step S6, the slew brake system operates in the emergency mode (or optionally the exception mode) to provide a mechanical braking effect in response to an emergency braking event. The controller 63 may be configured to operate the mechanical brake system 62 (at step S6) and the short-circuit brake system 58 (at step S2) simultaneously to provide the short-circuit braking effect and the mechanical braking effect to the electric slew motor 38. Therefore, in the emergency mode the mechanical brake system 62 is configured to engage the mechanical brake 68 if the rotational speed of a rotor of the electric slew motor is greater than the speed threshold. In an example, in the emergency mode the mechanical brake system 62 may be configured to disengage the mechanical brake once the rotational speed of a rotor of the electric slew motor 38 is reduced to less than or equal to the speed threshold. Advantageously, this may further reduce wear on the mechanical brake 68 and may also enable the electric slew motor 38 to decelerate and stop within a sufficiently small rotational distance. In an example, in the exception mode, the mechanical brake system 62 may be operated in response to one or more user inputs, and configured to engage, partially engage, and/or disengage the mechanical brake 68 until the speed of the electric slew motor 38 is reduced to a target speed and/or reaches a target position commanded by the one or more user inputs.

At decision step S7, the slew brake system may change from the normal mode to the exception mode in response to determining that the power sink (which may also be the power source 66) is at capacity or unavailable for receiving energy. For example, if the power sink is a battery, then the battery is at capacity when it is fully charged and cannot accept any more energy. The decision step S7 may be implemented by the slew brake system if the step S4 comprises the regenerative brake system 59. In an example, the regenerative brake system 59 makes it possible for the electric slew motor 38 to generate power such that the power sink may exceed its capacity. To avoid the power sink from exceeding its capacity, the slew brake system 50C may enter its exception mode and the flow chart 80B moves to step S2. If the power sink has capacity, then the flow chart 80B moves back to step S1.

Following step S7, at step S2, the slew brake system may operate in the exception mode to controllably operate the short-circuit brake system 58 to provide the short-circuit braking effect. As explained above, the exception mode if entered if the regenerative brake system 59 is unable to provide energy to the power sink 66. That is, the excess energy is dissipated as heat in the winding(s) of the electric slew motor 38. In the exception mode, the controller 63 may generate a variable (e.g., PWM) brake control signal to operate the short-circuit brake system 58 to selectively directly electrically couple the first and second terminals 54, 56 together to provide a short-circuit braking effect to decelerate the electric slew motor 38. In an example, the short-circuit brake system 58 may be operated to directly electrically couple the first and second terminals 54, 56 together until the electric slew motor 38 is brought to a stop. In an example, the short-circuit brake system 58 may be operated in response to one or more user inputs, and to directly electrically couple the first and second terminals 54, 56 together until the electric slew motor 38 is reduced to a target speed. In an example, the short-circuit brake system 58 may be operated in response to one or more user inputs, and to controllably directly electrically couple the first and second terminals 54, 56 together via a pulse width modulation signal until the electric slew motor 38 is reduced to a target speed and/or reaches a target position commanded by the one or more user inputs. In the exception mode, the controller 63 may generate the variable brake control signal to toggle the short-circuit brake system 58 and generate a constant (i.e., fixed) non-short-circuit control signal because the short-circuit brake system 58 is not in an emergency mode.

In an alternative example, the flow chart 80B does not comprise decision step S5 and in an emergency mode or an exception mode, the slew brake system operates step S6, simultaneously with step S2. In another alternative example with no decision step S5, and in an exception mode, the slew brake system operates step S6, alternately with step S2. With no decision step S5, after steps S6 and S2, the flow chart 80B may move back to step S1.

In an alternative example, the flow chart 80B does not comprise decision step S7. Decision step S7 may be dispensed if the slew brake system does not comprise a regenerative brake system 59. Decision step S7 may be dispensed if the working machine 10 comprises a hardware solution to dissipate energy generated by a regenerative brake system 59 if the power sink reaches capacity, such as a heat sink. With no decision step S7, after step S4, the flow chart 80B moves back to step S1.

At FIGS. 4 and 5, the inverter 52A is described as comprising switchable transistors 64a, 64b, 64c, 65a, 65b, 65c. In examples, the switchable transistors may be FETs, such as MOSFETs, IGBTs, or any other type of switchable transistor device.

Transistors 64a, 64b, 64c, 65a, 65b, 65c may be described as being arranged to be open or closed. In this context, a transistor arranged to be open results in its first and second channel terminals (e.g., source and drain for a MOSFET) not directly electrically coupled (e.g., via the transistor channel), i.e., the transistor is in its off-state. In addition, a transistor arranged to be closed results in its first and second channel terminals being directly electrically coupled (e.g., via the transistor channel) i.e., the transistor is in its on-state.

Examples of emergency braking events are described with reference to FIG. 2 and may comprise one or more of: activation of an emergency stop button; a determination that the power sink is at capacity (i.e., full) such that the regenerative brake system cannot provide further energy to the power sink; a hydraulic system fault event; a controller fault event; a loss of power; a loss of communication; or any fault detected by the working machine 10. For example, where the emergency braking event is the activation of the emergency stop button, the controller 63 receives a signal representing the activation of the emergency stop button and therefore determines the emergency braking event.

Although, the non-short circuit control signal, control signal, and brake control signals are described herein as separate and independent signals, in an example, two or more of these signals may be the same signal.

Although the disclosure has been described above with reference to one or more preferred embodiments, it will be appreciated that various changes or modifications may be made without departing from the scope of the disclosure as defined in the appended claims.

1. A working machine comprising:
a substructure;
a superstructure rotatable relative to the substructure about a generally vertical slew axis;
an electric slew motor arranged to slew the superstructure in rotation relative to the substructure about the slew axis;
a slew brake system comprising a motor driver circuit;
the electric slew motor comprising a motor winding with first and second terminals coupled to the motor driver circuit;
wherein the slew brake system is arranged to selectively directly electrically couple the first and second terminals together to provide a short-circuit braking effect.

2. The working machine according to claim 1, wherein the slew brake system is arranged to directly electrically couple the first and second terminals together in the absence of one of: a non-short-circuit control signal; or power to the slew brake system.

3. The working machine according to claim 1, wherein the motor driver circuit comprises switchable transistors configured to directly electrically couple the first and second terminals together.

4. The working machine according to claim 3, wherein the motor driver circuit is an inverter, and the inverter comprises the switchable transistors each having a control terminal and a first and second channel terminals, wherein each transistor is arranged such that its first and second channel terminals are directly electrically coupled when no control signal is present on its control terminal.

5. The working machine according to claim 1, wherein the slew brake system further comprises a mechanical brake system.

6. The working machine according to claim 5, wherein the slew brake system is configured to, in an emergency mode: directly electrically couple the first and second terminals together and operate the mechanical brake system simultaneously, to provide the short-circuit braking effect to the electric slew motor in response to a brake control signal.

7. The working machine according to claim 5, wherein the mechanical brake system comprises a mechanical brake, wherein the mechanical brake system is configured to operate the mechanical brake to provide a mechanical braking effect to the electric slew motor.

8. The working machine according to claim 7, the mechanical brake system is operated to: actuate the mechanical brake to disengage the mechanical brake; and, not actuate the mechanical brake to engage the mechanical brake to provide a mechanical braking effect to the electric slew motor.

9. The working machine according to claim 7, wherein the mechanical brake is actuated via a solenoid, wherein the solenoid is biased to engage the mechanical brake to provide a mechanical braking effect to the electric slew motor.

10. The working machine according to claim 7, wherein the mechanical brake is arranged to dissipate 6000 Joules of rotational energy from a rotor of the electric slew motor if the mechanical brake is engaged.

11. The working machine according to claim 7, wherein the mechanical brake system is configured to engage the mechanical brake if the rotational speed of a rotor of the electric slew motor is greater than a speed threshold.

12. The working machine according to claim 11, wherein the mechanical brake system is configured to disengage the mechanical brake once the rotational speed of a rotor of the electric slew motor is reduced to less than the speed threshold.

13. The working machine according to claim 1, wherein the electric slew motor is a 3-phase motor, wherein the first terminal is a U-terminal, the second terminal is a V-terminal, wherein the electric slew motor further comprises a W-terminal and a neutral terminal.

14. The working machine according to claim 1, wherein the emergency braking event comprises one or more of: a signal from an emergency stop button; a determination that the power sink is full such that the regenerative brake system cannot provide further energy to the power sink; a hydraulic system fault event; a controller fault event; a loss of power; a loss of communications.

15. The working machine according to claim 1, wherein the motor driver circuit is coupled to a power source and configured to operate the electric slew motor to slew the superstructure relative to the substructure.

16. The working machine according to claim 1, wherein the slew brake system comprises a regenerative brake system.

17. The working machine according to claim 16, wherein the regenerative brake system is configured to operate the motor driver circuit to receive energy from the electric slew motor operating as a generator and provides energy to a power sink such as an energy store or a system requiring electrical power, to provide a regenerative braking effect.

18. The working machine according to claim 17, wherein the slew brake system is further configured to, in an exception mode:
determine that the power sink is unavailable for receiving energy; and
directly electrically couple the first and second terminals together in response to determining that the power sink is unavailable.

19. The working machine according to claim 1, wherein the slew brake system is further configured to, in a normal mode:
detect one or more user brake inputs;
provide a mechanical braking effect and/or a regenerative braking effect based on the one or more user brake inputs; and,
not provide the short-circuit braking effect.
